(19) United States
(12) Patent Application Publication
(10) Pub. No.: US 2012/0323817 A1
(43) Pub. Date: Dec. 20, 2012

(54) Systems and Methods for Implementing a Separately Managed Account Platform

(75) Inventor: Marco Bitran, Brookline, MA (US)

(73) Assignee: ClearBridge, Inc., Boston, MA (US)

(21) Appl. No.: 13/428,538

(22) Filed: Mar. 23, 2012

Related U.S. Application Data
(60) Provisional application No. 61/466,806, filed on Mar. 23, 2011.

(51) Int. Cl. G06Q 40/06

(52) U.S. Cl. 705/36 R

(57) ABSTRACT

An SMA system that allows for efficient management of separately managed accounts across multiple investors. Electronic data interfaces exchange information between the SMA system and outside sources. The SMA system aggregates positions across the accounts and views those positions as one large account to generate block trades. The SMA system takes what was executed and updates accounts of individual investors based on the block trades.

### RELATED APPLICATIONS

This application claims benefit of co-pending U.S. Provisional Application No. 61/466,806 filed Mar. 23, 2011, entitled “Separately Managed Account Platform,” the disclosure of which is hereby incorporated by reference in its entirety.

### FIELD OF THE INVENTION

Embodiments consistent with the present invention relate generally to financial services, and more particularly, to a system that manipulates separately managed accounts across many investors.

### BACKGROUND OF THE INVENTION

A separately managed account (SMA) is an individual managed investment account offered typically by a brokerage firm through one of their brokers or financial consultants and managed by independent investment management firms. SMAs are generally useful tools for financial planning A hedge fund is an investment fund that can undertake a wider range of investment and trading activities than other funds, but which is only open for investment from particular types of investors specified by regulators. These investors are typically institutions, such as pension funds, university endowments and foundations, or high net worth individuals.

With a hedge fund, a manager has to manage only one single brokerage account. With SMAs, a manager needs to make separate trades for each account or do a block trade and then allocate the trade among a number of clients. Either way the separately managed account manager is subject to much more paperwork that is not only time consuming, but costly as well.

Hedge funds are finding it difficult to raise capital through traditional hedge fund channels, and the back-office costs to manage assets have increased. A new hedge fund must start its life with, for example, at least $100 million of assets under management (AUM) to be commercially viable. Further, the industry has changed and, as a result, investment managers are finding it more and more difficult to raise capital at a time when managing funds has become more costly. Almost all investment managers are desperate to raise capital regardless of the (AUM) base. Managers with $10 million AUM are highly eager to get to $50 million while managers with $500 million are highly eager to get to $1 billion. The need to grow has become one of survival and asset managers are becoming more interested in diversifying their businesses.

Some mutual funds offer alternative plans that provide investors with access to several hedge fund strategies, including global macro, long and short, market neutral, fixed income and convertible arbitrage, event driven and emerging market strategies. However, the investor is still subject to the risks of commingled funds. Unified Managed Accounts (UMAs) are available, but they have limitations, such as delegated trading, which is not acceptable to some managers. Additionally, UMAs cannot offer complex strategies and are limited to larger accounts.

SMAs offer many benefits relative to other investment structures. However, despite the benefits, SMAs are costly for investment managers to run and they are administrative burdens. Further, the investment options of a standard SMA are limited, in comparison to options offered by hedge funds. Moreover, a fundamental gap exists between the investors and fund managers with respect to the level of investment at which SMAs are attractive. Even the most sophisticated investors would be hard-pressed to find a fund manager willing to offer an SMA for a relatively small account.

Running an SMA is typically just as challenging and costly as running a second fund for investment managers. Most organizations are not operationally equipped to handle many SMAs. Creating an SMA involves setting up an account with a prime broker and a custodian for each individual client. The paperwork used for setting up an account typically involves at least 15-20 documents that require signatures. Monitoring and reporting for SMAs are challenging in that each client is unique and therefore requires the same efforts that a fund of investors would typically require. Managing one SMA can require additional personal, as each SMA is the equivalent of adding another fund. Fund managers are weighing the simple question of whether the additional operational burdens are worth taking on the fees and terms investors want.

### SUMMARY OF THE INVENTION

Embodiments consistent with the present application provide a technology solution in the form of an SMA system for investment managers. The SMA system enables managers to efficiently and cost effectively increase assets under management, and provides investors with liquid and transparent investment alternatives that would not otherwise be available to them. Investors using the system may include registered investment advisors (RIAs), individual investors, and those handling strategies, such as fund of funds, endowments, and pension funds.

According to an aspect, an SMA system is provided that has a first electronic data interface that receives information for multiple investment accounts. The information is stored such that an electronic computing unit manipulates data related to the information to provide consolidated account asset data. The consolidated account asset data represents the multiple investment accounts. A second electronic data interface exports the consolidated account asset data. A portfolio model is updated based on information received in response to the consolidated account data that was exported. A trade control module accesses the portfolio model, so as to generate a file based on information in the portfolio model. A third electronic data interface is used for transmitting a block trade request that is based on the file.

Embodiments consistent with the present application allow managers to increase assets under management, while not incurring additional costs or needing to hire additional personnel because, to the manager, it's similar to trading a single SMA. The investor owns the account and controls custody, while being provided with daily liquidity and full transparency. The investor also has access to diversified alternative strategies and a choice of high quality managers. Use of the SMA system is convenient due to an Internet platform.

These and other aspects, along with their attendant features, will be more fully appreciated upon a reading of the following detailed description along with the accompanying drawings.

### DESCRIPTION OF THE FIGURES

The following figures are presented for the purpose of illustration only, and are not intended to be limiting:

FIGS. 1 and 2 depict models in accordance with exemplary embodiments;

FIG. 3 illustrates an exemplary process flow for system logic;

FIG. 4 illustrates modules implemented on a server for creating an SMA system; and

FIG. 5 shows a platform for implementing an SMA system.

### DETAILED DESCRIPTION OF EXEMPLARY EMBODIMENTS OF THE INVENTION

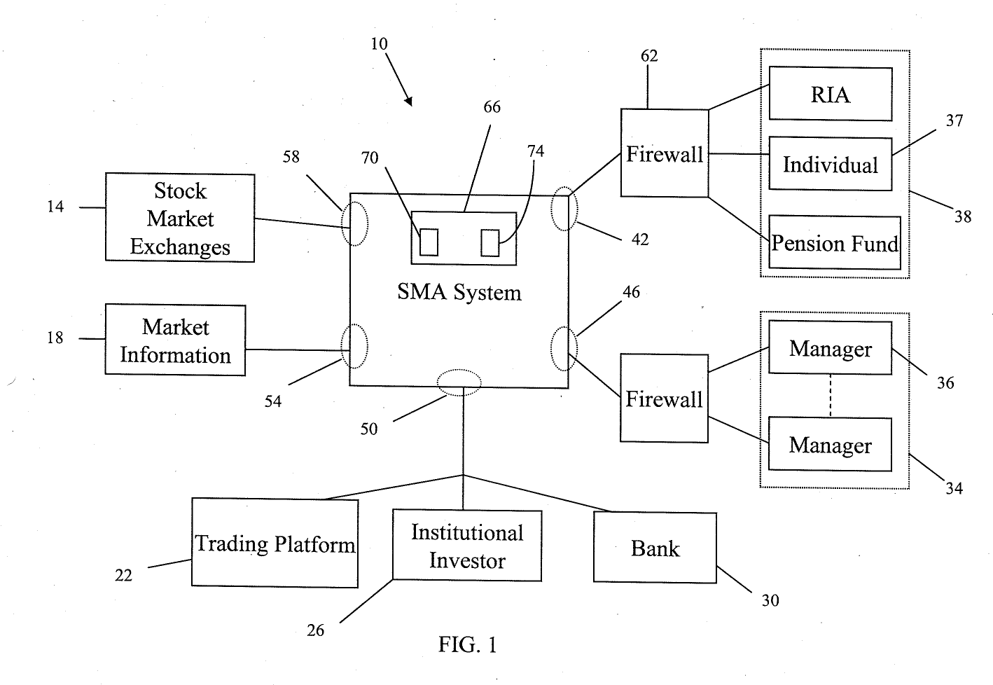

FIG. 1 illustrates a block diagram of an SMA system 10 in accordance with certain embodiments. The SMA system 10 allows for efficient management of separately managed accounts across, e.g., thousands of investors in long and short strategies. The SMA system 10 aggregates positions across the accounts and views those positions as one large account to generate trades. On the backend, the SMA system 10 takes what was executed and aggregates the large block trade to the accounts of individual investors.

The SMA system 10 communicates with various systems and devices. For example, the SMA system communicates with stock market exchanges 14, market information sources 18, and trading platforms 22. The SMA system 10 also communicates with custodians, such as institutional investors 26, and banks 30, along with money managers 34, and clients or investors 38. The SMA system 10 both receives information and sends information to these various entities and devices through electronic data interfaces 42, 46, 50, 54 and 58. The SMA system 10 receives data inputs from various sources such as hard drives, networks and the Internet. Firewalls 62 are used to provide the necessary security. Those skilled in the art will appreciate that the systems, technology platforms, and facilities, described herein and depicted in the drawings are implemented on computer systems, including main frame and desktop computers, that may be arranged in a network using well-known communication protocols.

An exemplary embodiment of the SMA system 10 runs on a server 66 that has at least one processor 70. The managers 34 can manage assets distributed over the multiple clients or investors 38. With respect to a single manager 36, the SMA system 10 provides a framework to manage what appears to be a single account of assets, but what is actually composed of accounts from a multitude of different investors 38. Modules and databases for implementing aspects of the SMA system 10, as described below in more detail, can be stored in any computer readable medium, such as the server's memory 74 and run by the server's processor 70. The processor 70 and the memory 74 on the server 66 form an electronic computing unit. The modules can be implemented in a programming language, such as, but not limited to, C++, Perl, VB, Java, XML, HTML, and SQL, and the like.

The SMA system's 10 ability to provide managers 34 with assets they can manage like a single fund brings down the cost of management and allows for a fund to start with less capital, as well as attract more capital. The investors 38 using the SMA system 10 may range, for example, from an individual to a pension fund with assets of a few thousand dollars to billions of dollars. The SMA system 10 provides a single account to both the investor, e.g., individual 37, and the manager, e.g., manager 36, to allow each to maintain control and manage a single account, while the SMA system 10 aggregates, propagates, and calculates information to enable both the managers 36 and the client 37 to view a single account that is composed of multiple assets from multiple sources. The SMA system 10 has the ability to receive data from multiple custodians and manipulate the data to a standardized and storable format. The data is stored in a database of memory 74 and is easily queried for input into trading and trade allocation modules, as discussed below in more detail. Likewise, as trade instructions are compiled, the SMA system 10 generates trade orders and allocation files that are in the unique formats of each custodian and thus easily executable.

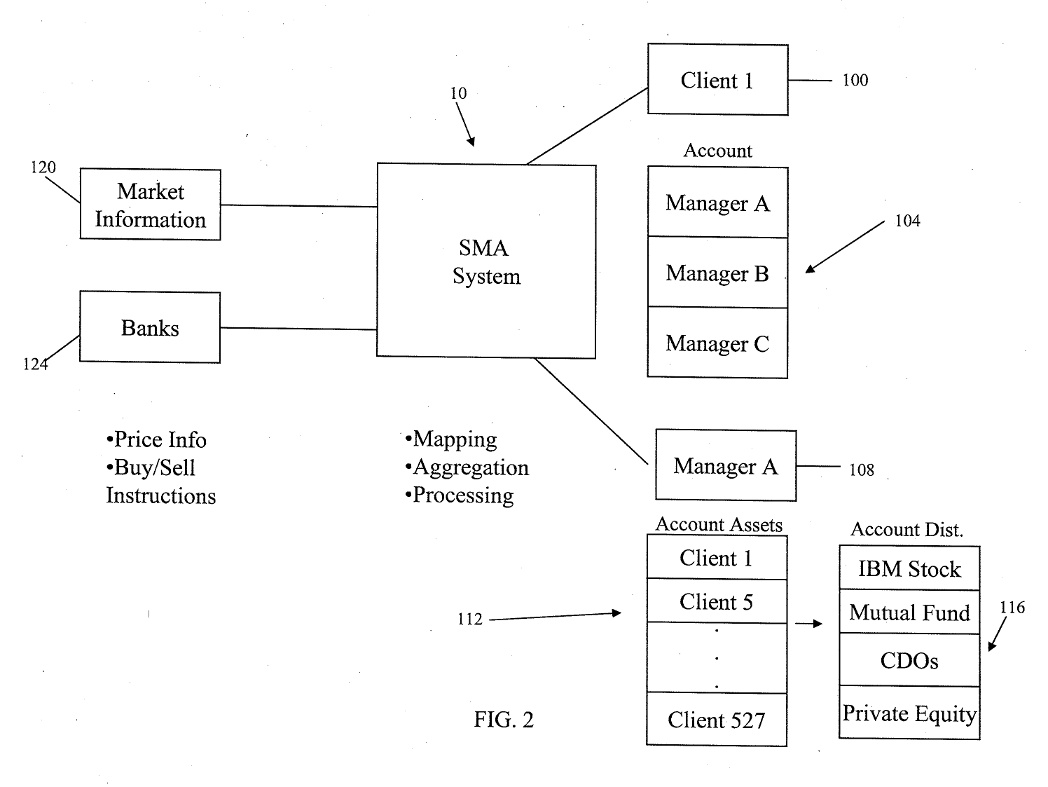

The SMA system 10 provides a controlled electronic interface between the investors 38 and the managers 34. An investor can be linked to one manager's strategy or can be linked to multiple managers. FIG. 2 shows a client 100 and his or her account 104 that is linked to three managers, A, B and C. The client may be an investor or someone acting on behalf of the investor. Each manager A, B and C may specialize in its own investment strategy and asset segment, hence providing greater opportunity for return on investment. For example, the client 100 may have $200,000 to invest and likes the respective strategies of managers A, B and C. The $200,000 can put into three different accounts that correspond to the three different mangers, such that, for example, $100,000 goes into an account with manager A; $50,000 goes into an account with manager B; and $50,000 goes into an account with manager C. Alternatively, the money can be put into one account, while indicating that manger A should manage 30%, manager B should manage 30%, and manager C should manage 40%. The SMA system 10 keeps track of the client's desired account allocations. Because the SMA system may be handling thousands of clients, the SMA system's 10 software and computer are necessary to track and aggregate the clients' information.

The managers associated with the SMA system 10 provide recommendations for what looks like a single account, but which is actually composed of thousands or even tens of thousands of clients. For example, manager A 108 is shown as managing account assets 112 from clients 1 and 5-527, but to the manager A 108, this appears as a single account. Manager A 108 takes the account assets 112 and determines how they should be distributed among investments of the manager A's 108 choosing. In this example, manager A 108 specializes in a particular type of account distribution 116 having commodities and funds, including IBM stock, mutual funds, collateralized debt obligations (CDOs) and private equity. Manager A 108 views the account assets 112 as a single asset block, while the account assets 112 actually represent the accumulated assets of clients 1 and 5-527. Information sent to Manager A 108 may include, for example, the amount of money that the clients want to invest as a whole, a type of strategy or model that is desired, along with the existing holdings of the clients. Thus, manager A 108 may not need to hire additional people to manage the thousands of individual accounts that may cumulatively make up the account assets 112, since this management work is outsourced to the SMA system 10. Manager A 108 therefore benefits by having an increased amount of assets under management, while having the administrative responsibilities of managing only one account.

Manager A 108 provides trade recommendations and positions, such as buy and/or sell, for example, to the SMA system 10 for the account assets 112, through a communication channel, such as the electronic data interface 46 in FIG. 1. The SMA system 10 also receives trade recommendations and positions from the other managers, such as managers B and C, for the account assets that they manage. The SMA system 10 then determines what trades need to be made, for which accounts and through which custodians. The SMA system 10 takes into consideration market information and prices 120 when determining what trades are needed. The SMA system 10 uses market prices in combination with the recommendations and positions from the managers to determine what quantity to trade. The market prices may be communicated to the SMA system 10 through the electronic data interface 54 of FIG. 1.

The SMA system 10 allows for a high level of customization of a separately managed account. The client 100, such as an individual investor or investor group, has the ability to create a customized portfolio or investment strategy to suit their particular financial situation or preferences. For example, the client 100 may customize a portfolio based on factors, such as optimal tax loss harvesting and whether sin stocks are included, and the like. These preferences can be taken into account without a burden on the manager 108 because the client's account can be configured so that if the manager 108 recommends buying sin stock and the client's account has a restriction on sin stocks, the SMA system 10 will not make the sin stock purchase for the client 100. The processor 70 of the SMA system 10, shown in FIG. 1, scans the mass amounts of client information stored in the memory 74 to identify any restrictions. Because thousands of investors may have information stored in the SMA system 10, use of the processor 70 and memory 74 makes this and other aspects of the SMA system 10 possible.

After the SMA system 10 determines what trades are needed, an entity registered with the stock market exchange, such as the institutional investors 26 or bank 30 in FIG. 1, is instructed electronically by the SMA system 10 to make the appropriate trade. After the trade is complete, the SMA system 10 is updated to represent changes to the clients' accounts due to the trade. The clients can receive trade confirmations directly through their custodians by logging into the custodians' Internet portal. The clients have daily liquidity because they can liquidate any or all strategies that are implemented for their accounts at any time. In an embodiment, this is done by providing a request through the electronic interface 42 shown in FIG. 1.

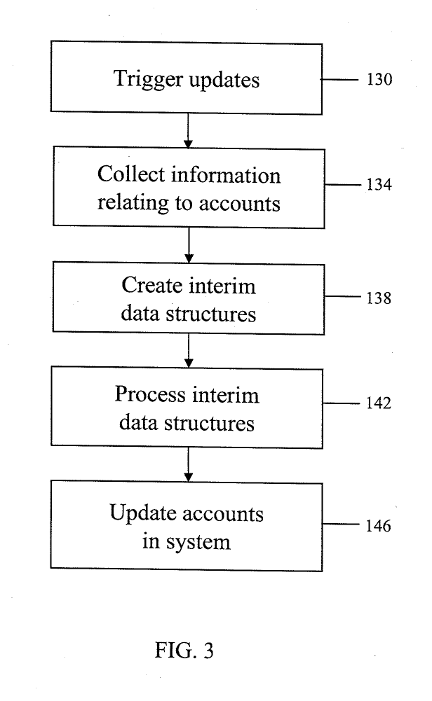

With additional reference to FIG. 3, a process flow is illustrated for updating client accounts in the SMA system 10. An update is triggered by information received from systems or devices that communicate electronically with the SMA system 10 through the interfaces 42, 46, 50, 54 and 58 of FIG. 1. (operation 130). For example, manager A 108 may send new purchase recommendations for the account assets 112 shown in FIG. 2. The SMA system 10 collects information related to the account assets 112 and the associated clients to determine what changes are needed (operation 134). Because the account assets 112 may represent thousands of clients, the SMA system 10 creates interim data structures that are stored in the memory 74 of FIG. 1 to hold information pertaining to the accounts and to aggregate, propagate, and process changes needed for following the new purchase recommendations (operation 138). The interim data structures are then processed in the SMA system (operation 142) so that trades can be conducted in accordance with the newly receive recommendations and the accounts can be updated. (operation 146). The above described process flow represents an exemplary algorithm for managing multiple clients and multiple managers on a platform.

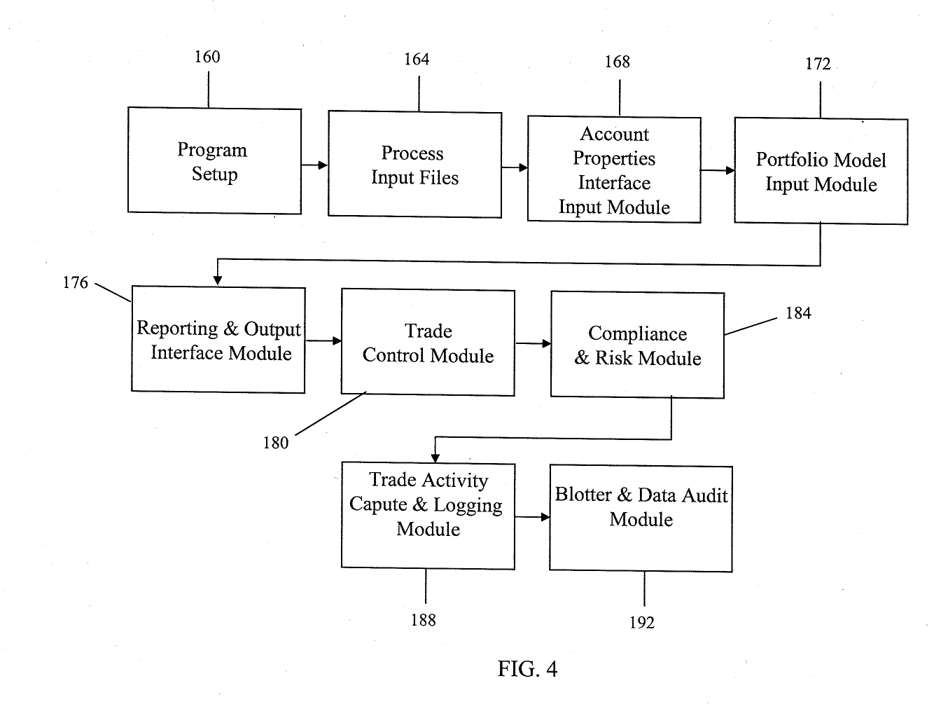

The SMA system 10 uses logic and interim data structures to maintain and manipulate the individual client accounts, so that block trades are made on behalf of a large group of clients and the results of the block trades are proportioned to the respective client accounts. Thus, the SMA system 10 provides an efficient and orderly way of investing for both clients and managers. With additional reference to FIG. 4, modules are illustrated that are used to carry out functions of the SMA system 10. The modules can be implemented using any combination of hardware or software, including, but not limited to, the processor 70 and the memory 74 of the server 66, shown in FIG. 1.

A program setup module 160 provides several support functions to the SMA system 10 and its operating programs. These include password protection that prevents unauthorized access and writing capabilities. The program setup module 160 also assigns certain file attributes to input and output files so that files are not overwritten or read while open.

The program setup module 160 downloads files from brokers or custodians, such as the institutional investors 26 and banks 30 shown in FIG. 1. These files contain account information, position information and activity reports. The files are downloaded from the brokers and read into the database of memory 74. During the read procedure, the program setup module 160 may parse the files to ensure that there have not been any format changes by the broker. The program setup module 160 verifies syntax and then populates the database with the downloaded records.

A process input files module 164 parses the data read in by the program setup module 160 and creates multiple interim data structures that are useful for future processing. For example, the process input files module 164 aggregates all of the positions held by each account into a data structure for the account, so that the account can be quickly accessed and its positions read. In general, the process input files module 164 handles the parsing and reading of raw database records, and the creation of interim data structures that allow for efficient and orderly sorting, reading, and processing of data in other modules.

An account properties module 168 provides a user interface to allow a user to input codes for accounts, set account properties, fill in account information in fields, and to save such information in the server's memory 74. Such account information may pertain to establishing whether the account should be flagged for liquidation; determining whether any restrictions exist for the account; and determining whether or not the account is compliant to be traded.

The account properties module 168 also allows the user to sort accounts by various criteria, such as by account number, by name, by asset size, by inception date, by whether or not the account is active, and by the accounts with capital flows. The user can also filter the accounts using criteria, such as the amount of assets in the accounts. In an embodiment, the user interface of module 168 is accessed by logging into the SMA system 10 and communicating through the interface 42, shown in FIG. 1. The account properties module 168 may also be accessed by an administrator of the SMA system 10.

A portfolio model input module 172 is provided so that a portfolio manager or an operational user or administrator, depending on the operational setup between the manager and the operator of SMA system 10, enters in an appropriate trading model, or portfolio model, for each manager. For example, the portfolio manager might enter in the following model, which enumerates the positions that the designated account(s) should contain, and the percentage allocation:

| | |
|---|---|
| IBM | 5% |
| CSCO | 20% |
| CX | 30% |
| GOOG | 40% |
| INTC | 5% |

A typical portfolio model may have many more positions. The portfolio model input module 172 allows for multiple models to be created, for the models to be applied to certain groups of accounts, and for the models to be stored and modified over time. In an embodiment, each time a model is updated, real-time and last close prices are dynamically downloaded so that the SMA system 10 stays current on pricing data. The SMA system 10 may receive the model electronically through, for example, the interface 46 of FIG. 1.

A reporting and output module 176 provides a user interface that reports the accounts to the user and allows the user to view the accounts for pre-trading purposes. The reporting and output module 176 presents the user with a way to quickly see an account overview. The reporting and output module 176 allows the user to aggregate accounts and view total assets under management, which accounts need rebalancing, and if so, for which reasons. The reporting and output module 176 also allows users to view account levels and aggregate level statistics graphically, making it easy to identify potential issues and to observe and analyze a large number of accounts quickly.

A trade control module 180 is provided that accesses client instructions to apply portfolio models to certain groups of accounts. It allows the user to apply a portfolio model using certain formulas, such as “% rebalance,” “limited security inventory spreading,” “flows only,” “manual,” and with certain limiters such as “for certain tickers only,” “for certain accounts/account types only,” “for certain brokers only,” “for certain advisors only.” The trade control module 180 generates block trade files based on the application of the portfolio models in the manner specified, and also creates a corresponding allocation file, per execution party or broker, and by manager or program as needed. The trade control module 180 can output the data to the user electronically through the interface 42 of FIG. 1, so the user can view the data both in list form, and graphically, to help spot any user errors. The generated files are then sent or transferred through the electronic interface 50, shown in FIG. 1, to the respective brokers or custodians for trading and later for allocation. In exemplary embodiments, the block trade files include an aggregated number of shares from the underlying custodian accounts to be executed via one trade per security. An allocation file contains the detail on which accounts to allocate the shares upon execution of the block trade.

A compliance and risk module 184 is used to interface with the trade control module 180 to trap trades that would violate programmed compliance rules. For example, a user may have specified that no single security should be more than 10% of any account's net asset value or that no sin stocks should be purchased. In such a case, the compliance and risk module 184 would trap a violating trade prior to it being generated for block or individual account execution.

A trade activity capture and logging module 188 reads in, processes, parses and loads into the SMA system memory 74 all trade activity, including block trading files that were generated, allocation files that were generated, and any activity reports. The SMA system 10 may balance accounts using multiple schemas, such as, but not limited to an equally weighted approach, or balanced according to flows and percentages, or based on asset balancing. The SMA system 10 generates trades for each account, and pre-fills the trades into a pre-trade blotter and displays each security traded as a percentage of an account's net worth, in addition to other statistics.

A blotter and data audit module 192 creates a snapshot of all accounts and trade data that flow through the system, and creates a daily audit file which stores all of this information, along with the portfolio models, and any other relevant data, for audit trail purposes.

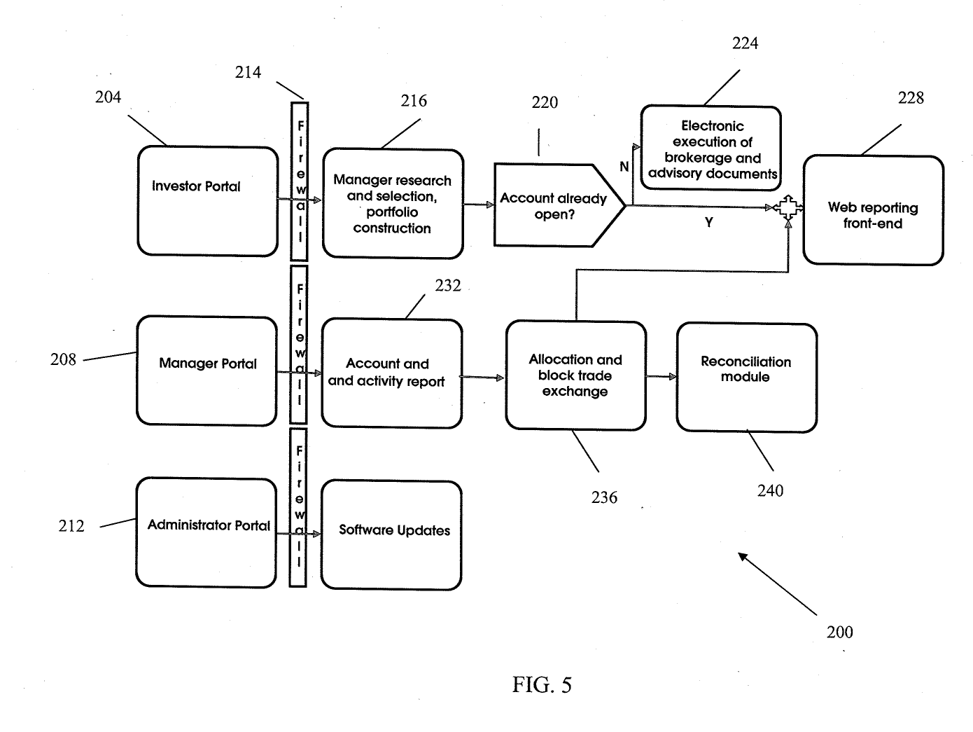

Embodiments consistent with the present disclosure include accessing the SMA system 10 through the Internet. With additional reference to FIG. 5, an Internet based platform 200 for the SMA system 10 is shown. Users of the platform 200 include investors of many forms, as noted above, such as, RIAs, individual investors, and those handling strategies, such as fund of funds, endowments, and pension funds, and the like. The investors can access the platform 200 through a publically available front end portal 204. Investment managers and administrators also have portals 208 and 212 for access to the platform 200. A firewall 214 is used to provide secure access technology. The platform 200 of FIG. 5 may be implemented on the sever 66 of FIG. 1 and hosted in an Internet “cloud” to provide access to users and user groups via the Internet and other data interface formats.

In an embodiment, the front end portal for investors 204 includes a manager research and selection module 216 that collects manager data and presents it in user accessible formats. This allows users or investors to view managers that are associated with the SMA system 10. An investor can also view and configure desired portfolios using the module 216. A new account module 220 will determine if an investor already has an account, and an electronic forms module 224 will provide the option of opening an account online so that the investor can easily execute investment advisory agreements and contracts. Thus, clients can open accounts electronically, with minimal or in some cases, zero amounts of paperwork, and electronically subscribe to managers using the platform 200. After an account is established, performance, account activity, and taxes, for example, are reported to the investor through a front-end module 228.

Managers can use the manager portal 208 to view information in the SMA system 10. An account and activity report module 232 is used to aggregate and roll up the account asset information into a single reportable line item, with asset size, activity, and position reports, as if it was a single account. This saves the managers from dealing with the operational complexity and burden of handling multiple managed accounts.

The platform 200 also provides a module 236 for accepting and processing block trade data or trade activity, creation of allocation files for the broker, and collection of performance data and other collateral strategy information from the manager. In an embodiment, when the SMA system 10 instructs a custodian or broker to make trades, the trades are technically executed in one account. Once the trade is executed, the module 236 gives instructions as to which specific client accounts to place the shares. For example, the module 236 will instruct a broker to buy 100 shares of a security for placement into a master account. After the trade is executed, the module 236 will then indicate that 30 shares go to account number one, 40 shares go to account number two, and 30 shares go to account number three. After the trades are executed, a reconciliation module 240 ensures that trades reported by the broker or custodian match the records stored in the memory 74 of the SMA system 10.

The platform includes an administrator portal 212 that allows system administrators to provide updates to software and user interfaces, fix bugs and correct other software issues, while also being able to roll out new software versions by upgrading the cloud-based software. Therefore users will not need to download and install software packages on their own computers and in their workplace environments, since the SMA system 10 is accessible via a Web or Internet browser. The administrator may also use the portal 212 to enter or edit a trading model or portfolio model based on information received from managers or investors, if this information is not automatically entered into the SMA system using the sever 66.

As will be apparent to one of ordinary skill in the art from a reading of this disclosure, embodiments of the present disclosure can be embodied in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. The scope of the invention is as set forth in the appended claims and equivalents thereof, rather than being limited to the examples contained in the foregoing description.

I claim:

1. An SMA system, comprising:
a first electronic data interface that receives information for multiple investment accounts;
a memory that stores the information;
an electronic computing unit that manipulates data related to the information to provide consolidated account asset data, the consolidated account asset data representing the multiple investment accounts;
a second electronic data interface that exports the consolidated account asset data,
a portfolio model that is operable to be updated based on information received in response to the consolidated account data that was exported;
a trade control module that accesses the portfolio model, the trade control module generating a file based on information in the portfolio model; and
a third electronic data interface that transmits a block trade request based on the file.

2. The system of claim 1, comprising a compliance module that interfaces with the trade control module to identify trades that would violate programmed compliance rules.

3. The system of claim 2, wherein the compliance module determines if a type of stock should not be purchased for at least one of the investment accounts.

4. The system of claim 1, wherein the system accommodates at least a thousand of the investment accounts, and the system comprises a process input file module that aggregates positions held by each of the at least a thousand of the investment accounts into a data structure.

5. The system of claim 1, comprising an account properties module that indicates whether at least one of the multiple investment accounts should be flagged for liquidation.

6. The system of claim 1, wherein the portfolio model represents long and short investment strategies.

7. The system of claim 1, comprising an investor portal that permits access to the system using an Internet.

8. The system of claim 7, comprising a manager portal that permits access to the system using the Internet.

9. The system of claim 1, comprising a computer processor of a server that is used for creating the consolidated account data.

10. The system of claim 1, comprising an electronic database that is updated after the block trade is conducted, wherein updates are made for all of the multiple investment accounts.

11. A method for providing a separately managed account system, comprising:
establishing a first electronic data interface that receives information for multiple investment accounts;
storing the information in memory;
manipulating data related to the information to provide consolidated account asset data, the consolidated account asset information representing the multiple investment accounts;
establishing a second electronic data interface that is used to export the consolidated account asset data,
updating a portfolio model based on information received in response to the consolidated account data that was exported;
generating a file based on information in the portfolio model; and
transmitting a block trade based on the file through a third electronic data interface.

12. The method of claim 11, comprising using a compliance module to identify trades that would violate programmed compliance rules.

13. The method of claim 12, wherein the compliance module determines if a type of stock should not be purchased for at least one of the investment accounts.

14. The method of claim 11, comprising accommodating at least a thousand of the investment accounts and aggregating positions held by the at least a thousand investment accounts into a data structure.

15. The method of claim 11, comprising using an account properties module to indicate whether at least one of the multiple investment accounts should be flagged for liquidation.

16. The method of claim 11, comprising representing long and short investments strategies in the portfolio model.

17. The method of claim 11, comprising providing an investor portal that is operable to receive investor input by using an Internet.

18. The method of claim 17, comprising providing a manager portal that is operable to receive manger input by using the Internet.

19. The method of claim 11, comprising using a computer processor of a server to create the consolidated account data.

20. The method of claim 11, comprising updating an electronic database of the system after the block trade is conducted, wherein updates are made for all of the multiple investment accounts.
